(19) United States
(12) Patent Application Publication
(10) Pub. No.: US 2015/0076199 A1
(43) Pub. Date: Mar. 19, 2015

(54) CUSTOMIZABLE SHOPPING CART INSERT

(71) Applicant: Karla Granvle, Arlington, TX (US)

(72) Inventor: Karla Granvle, Arlington, TX (US)

(21) Appl. No.: 14/488,280

(22) Filed: Sep. 16, 2014

Related U.S. Application Data
(60) Provisional application No. 61/878,551, filed on Sep. 16, 2013.

(51) Int. Cl. B62B 5/00

(52) U.S. Cl. CPC B62B 5/00
USPC 224/411

(57) ABSTRACT

The invention disclosed herein provides an apparatus, system and method for organizing a grocery cart. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CLAIM OF PRIORITY

This utility patent application is related to and claims priority from pending U.S. Provisional Patent Application No. 61/878,551 entitled CUSTOMIZABLE SHOPPING CART INSERT to common inventor Granvle, filed on Sep. 16, 2003.

### TECHNICAL FIELD OF THE INVENTION

The present invention relates to shopping cart devices.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

For decades, many have sought systems and methods for organizing items in a shopping cart. However, while shopping small items fall between wires in a shopping cart. Additionally, other items such as eggs, may shift and crack or break. Further, soft items such as bread fall between other items and get squished

and who likes smushed bread? Lastly, because items can shift, shift and move around, the open-nature of shopping carts makes organizing for a shopping trip difficult—particularly at grocery stores. The present invention provides a system and apparatus that overcome the disadvantages of the current state of the art in shopping cart experiences.

### BRIEF DESCRIPTION OF THE DRAWINGS AND TABLE

Various aspects of the invention, as well as an embodiment, are better understood by reference to the following detailed description. To better understand the invention, the detailed description should be read in conjunction with the drawings, in which, unless otherwise stated, like numberals represent like objects.

FIG. 1 illustrates a shopping cart having an inventive shopping cart insert.

FIG. 2 shows a side-view of the inventive shopping cart insert.

FIG. 3 shows an alternative embodiment of the inventive shopping cart insert.

### DETAILED DESCRIPTION OF THE INVENTION

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “attaching” may be done by hook-and-loop attachment (such as Velcro®), snaps, hooks, belts, etc., and so a use of the word attaching invokes all methods of attachment known in and anticipated by the art, and all other modes of that word and similar words).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. The numerous innovative teachings of present application are described with particular reference to presently preferred embodiments.

### DESCRIPTION OF THE DRAWINGS

The invention is a shopping organizer insert (“insert”) that is designed to fit in any of the standard sized shopping cart, or which may be “custom” sized for any particular shopping cart model. The insert is preferably made out of a mesh material, such as a washable nylon, however it is appreciated that other materials may be utilized, such as neoprene, cloth, or canvass, for example. Additionally, the insert's material may be coated with any available treatment or coating, such as an insulation, a water-proofing coating—such as plastic, or a food-preservative coating such as TiO2, for example.

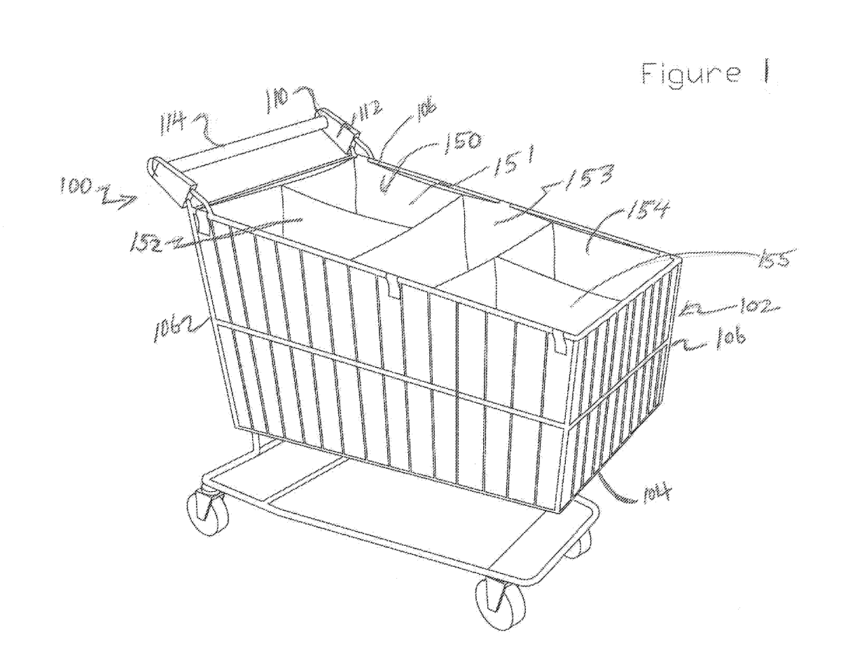

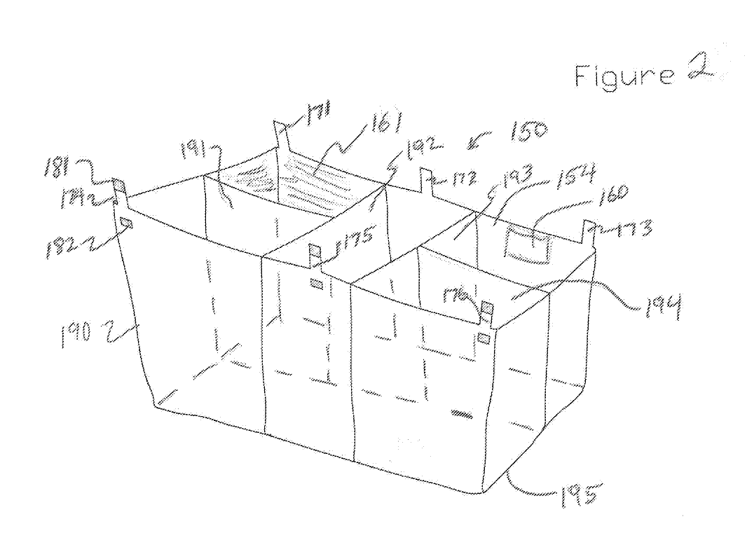

Simultaneous reference is made to FIGS. 1 and 2, in which FIG. 1 illustrates a shopping cart 100 having an inventive shopping cart insert 150, while FIG. 2 shows a side-view of the inventive shopping cart insert 150. In a preferred embodiment, the insert 150 has five compartments 151-155 that may receive items to be purchased. The shopping cart 100 including a basket portion 102, having a bottom 104, and a plurality of sides 106 coupled thereto and extending upwardly therefrom. The basket portion 102 thus defines an interior space for storing articles therein. Also included is a plurality of wheels coupled to the bottom 104 of the shopping cart 100 for transporting purposes.

The shopping cart 100 further includes a handle assembly 110 having a pair of substantially vertical posts 112 with inboard ends coupled to the sides 106 of the shopping cart 100 and extending upwardly and rearwardly therefrom. Associated therewith is a substantially horizontal handle 114 coupled to outboard ends of the posts 112. Such handle 114 further includes a grip for being handled by a user to maneuver the shopping cart 100. In one embodiment, the grip includes a substantially tubular configuration and is constructed from a plastic material. In various other embodiments, the grip may be constructed from a separate or integral metallic or elastomeric piece, or any other material with any desired type of configuration that is capable of being gripped by a user.

While a shopping cart 100 is specifically described, it should be noted that the principles set forth herein may be applied in the context of any cart-like device. For example, an airport luggage cart, any cart used by multiple users, or any other cart-like device may be considered within the scope of the present invention.

As seen more easily in FIG. 2, the insert 150 includes a coupon pouch 160 in a fourth compartment 154, which of course could be in any or each compartment 151-155. Also viewable in FIG. 2 is a compartment lining (or “coating”) 161 in the first compartment 151, which may be an insulation, a water-proofing coating such as plastic, or a food-preservative coating such as TiO2, for example. Additionally, the insert 150 includes tabs 171-176, which are securable to the sides 106 of the shopping cart 100 with attachment members such as hook-and-loop (sometimes called “Velcro®”) attachments 181, 182 and the like.

While a hook-and-loop attachment 181, 182 is specifically described, it should be noted that the principles set forth herein may be applied in the context of any attachment member. For example, straps, ties, belts, or bucklings or equivalents may be considered within the scope of the present invention. Of course, depending on the embodiment, a tab may comprise a portion of an attachment member.

Each compartment 151-155 has a plurality of sides formed from the intersections of a side of the insert's periphery 190, and one or more of a plurality of interior sides 191-195, and having preferably a unified bottom 195 at the base of the periphery 190 and an opening about a top of the periphery (where the tabs 171-176 are located).

The insert 150 may have additional compartments in the vertical and/or horizontal dimensions such that any compartment may collapse in any direction; this allows a user to adjust the compartments that they wish to use (make available) in the cart, and which ones they wish to collapse out of the way. In a preferred embodiment, the insert 150 folds into a small briefcase/handbag size tote, and includes handles for carrying a folded insert.

Preferably, each compartment 151-155 is connected to form a unified, collective insert 150. The connection may be accomplished (where not formed of a unified material such as on the perimeter of the insert 150), via sewing, stiching, heat-pressing/forming or other methodologies known in the art.

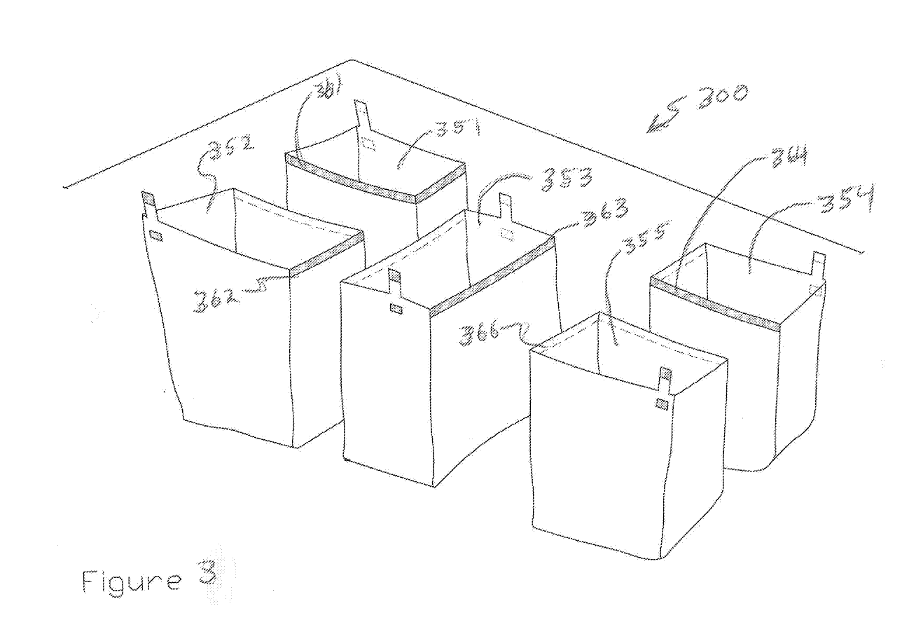

FIG. 3 shows an alternative embodiment of the inventive shopping cart insert 300. In this embodiment the compartments 351-355 are seperatable, and couplable via attachment means, such as paired hook-and-loop attachments 361-366 which are attached to each interior lip portion of the compartments 351-355. Although not shown in FIG. 3, in one embodiment each compartment 351-355 may also include a handle for utilizing each compartment as a separate bag. This embodiment has an advantage in that it enables a user to customize a shopping cart insert arrangement for any particular shopping trip.

Using the organizer prevents bread from being smashed, eggs from being crushed, and boxed food items from getting damp via frozen food condensation, so the consumer no longer has to organize their groceries on the fly in the cart as a whole, they can simply place the items in a compartment of the organizer There may or may not be labeling on the compartments, as needed to balance flexibility with organization, but preferably no labeling is necessary. Organizing items for purchase also gives the shopper a way to indicate to the bagger “how” the groceries should be grouped.

For those that love shopping, the shopping experience will be even more wonderful because the shopper has more control over how the groceries are bagged at the check out. For all of the coupon and extreme coupon shoppers there is no need to have a grocery cart running over with coupons and catalogs—simply place them in one of the compartments and put the corresponding coupon(s)/etc. in the same compartment, and when the shopper arrives at the register, the process of using the coupons is facilitated.

For those that do not like shopping, organizing what is in a basket reduces shopping anxiety, and can help the experience go by more quickly. For the grocery store (or other store), the organizer helps to keep the check-out lines as short as possible.

Though the invention has been described with respect to specific preferred embodiments, many variations and modifications will become apparent to those skilled in the art upon reading the present application. Specifically, the invention may be altered in ways readily apparent to those of ordinary skill in the art upon reading the present disclosure. It is therefore the intention that the appended claims and their equivalents be interpreted as broadly as possible in view of the prior art to include all such variations and modifications.

I claim:

1. A system for organizing a shopping cart, comprising:
a cart comprising
a basket portion having a bottom, and a plurality of sides coupled thereto and extending upwardly therefrom, the basket portion thus defining an interior space for storing articles therein,
a plurality of wheels coupled to the bottom of the shopping cart,
a handle assembly having a pair of substantially vertical posts with inboard ends coupled to the sides of the cart and extending upwardly and rearwardly therefrom, and
a substantially horizontal handle coupled to outboard ends of the posts;
a cart insert made of mesh material, comprising
a periphery being at least a four sided exterior portion, and defining an interior,
at least a first interior side coupled to the periphery within the interior,
a bottom coupled to a base of the periphery, and at least a first tab coupled to a top of the periphery, the first tab having a first attachment member coupled thereto; and
the insert coupled within the cart, and secured to the cart with at least the first attachment member.
